(19) United States
(12) Patent Application Publication
(10) Pub. No.: US 2018/0252579 A1
(43) Pub. Date: Sep. 6, 2018

(54) DEVICE AND METHOD FOR INTEGRATED OPTICAL MEASUREMENT

(71) Applicant: ELECTRONICS AND TELECOMMUNICATIONS RESEARCH INSTITUTE, Daejeon (KR)

(72) Inventors: Hyun Seo KANG, Gwangju (KR); Jeong Eun KIM, Gwangju (KR); Jaisang KOH, Gwangju (KR); Keo-Sik KIM, Gwangju (KR); Sung Chang KIM, Gwangju (KR); Hee Seung KIM, Gwangju (KR); Ji Hyoung RYU, Jeonju-si (KR); Hyoungjun PARK, Gwangju (KR); Dong Hoon SON, Jeollanam-do (KR); CHAN IL YEO, Gwangju (KR); Young Soon HEO, Gwangju (KR)

(73) Assignee: ELECTRONICS AND TELECOMMUNICATIONS RESEARCH INSTITUTE, Daejeon (KR)

(21) Appl. No.: 15/825,303

(22) Filed: Nov. 29, 2017

(30) Foreign Application Priority Data
Mar. 6, 2017 (KR) 10-2017-0028521

(51) Int. Cl. G01J 3/02; G01J 3/10; G09G 3/20

(52) U.S. Cl. CPC G01J 3/0227; G01J 2003/102; G09G 3/2003; G01J 3/10

(57) ABSTRACT

An integrated optical measurement apparatus includes: an optical signal transmission unit varying a wavelength of an optical signal to be transmitted and controlling power of the optical signal such that the wavelength is varied to be output to the outside; an optical signal receiving unit measuring power and a wavelength from the optical signal input from the outside; and a controller controlling the optical signal transmission unit and the optical signal receiving unit.

### CROSS-REFERENCE TO RELATED APPLICATION

This application claims priority to and the benefit of Korean Patent Application No. 10-2017-0028521 filed in the Korean Intellectual Property Office on Mar. 6, 2017, the entire contents of which are incorporated herein by reference.

### BACKGROUND OF THE INVENTION

### (a) Field of the Invention

The present invention relates to a method and an apparatus for integrated optical measurement, and in detail, relates to a method and an apparatus for integrated optical measurement for varying a wavelength of an optical signal and discriminating power and a wavelength of an optical signal input from the outside.

### (b) Description of the Related Art

An optical measuring instrument is equipment for measuring various physical characteristics of a target to be measured, and various measuring instruments are currently used in many places. As optical measuring instruments mainly and widely used in an optical communication field, there are a measuring laser source, an optical power meter, an optical spectrum analyzer, a wavelength meter, etc.

Currently, an optical measuring instrument that is widely used as a measuring instrument is one in which a tunable laser source and an optical power meter are composed as one apparatus, and has an optical wavelength tunable function and an optical power measuring function.

The optical measuring instrument is used by mainly separating the optical wavelength tunable/optical power measuring function and the optical wavelength measuring/optical power measuring function. Accordingly, it is inconvenient to use the plurality of optical measuring instruments to measure several functions of the target to be measured.

### SUMMARY OF THE INVENTION

The present invention provides a method and an apparatus for integrated optical measurement that may be manufactured with a low cost while realizing a tunable optical wavelength source, and optical power measuring and optical wavelength measuring functions are performed by one apparatus.

According to an exemplary embodiment of the present invention, an integrated optical measurement apparatus receiving an optical signal and processing the received optical signal is provided. An integrated optical measurement apparatus includes: an optical signal transmission unit varying a wavelength of an optical signal to be transmitted and controlling power of the optical signal such that the wavelength is varied to be output to the outside; an optical signal receiving unit measuring power and a wavelength from the optical signal input from the outside; and a controller controlling the optical signal transmission unit and the optical signal receiving unit.

The optical signal transmission unit may include: at least one wavelength tunable transmission unit varying the wavelength of the optical signal to be transmitted; a combination and distribution unit combining at least one of optical signals respectively output from the wavelength tunable transmission unit and having the varied wavelength; an amplification and power controlling unit controlling power of the optical signal combined by the combination unit; and an output unit outputting a signal of which the power is controlled.

The optical signal transmission unit may further include a driving board unit controlling driving of at least one wavelength tunable transmission unit to provide the corresponding wavelength depending on wavelength information received from the controller.

The at least one wavelength tunable transmission unit may respectively include at least one diode chip, and the driving board unit may change a current flowing to the at least one diode chip depending on the wavelength information to vary the wavelength of the optical signal.

The optical signal transmission unit may further include a power controller controlling the amplification and power controlling unit depending on the control of the controller.

The at least one wavelength tunable transmission unit may be implemented as a transistor outline (TO)-CAN package or a mini flat package.

The optical signal transmission unit may further include a wavelength locker fixing the wavelength of the input optical signal, and the combination and distribution unit may distribute the combined optical signals and then output one optical signal to the amplification and power controlling unit and output the other optical signal to the wavelength locker.

The optical signal receiving unit may include: a first optical separator branching the received optical signal; a power measuring unit receiving one optical signal output from the first optical separator to be converted into an electrical signal; a power control board unit measuring the power of the electrical signal output from the power measuring unit; at least one linear transmission filter generating a power change for each wavelength from the other optical signal output from the first optical separator; at least one wavelength measuring unit converting the optical signal passing through the at least one linear transmission filter into the electrical signal; and a wavelength control board unit measuring the wavelength from the electrical signal output from the at least one wavelength measuring unit.

The optical signal receiving unit may further include at least one second optical separator branching the other optical signal and outputting one branched optical signal to the corresponding linear transmission filter, and the at least one second optical separator may output the other branched optical signal to a second optical separator that is positioned next.

The optical signal receiving unit may include: an optical distributor outputting the optical signal respectively received through the plurality of output ports; a power measuring unit connected to a first output port among the plurality of output ports and receiving the optical signal output through the second output port to be converted into the electrical signal; a power control board unit measuring power from the electrical signal output from the power measuring unit; at least one linear transmission filter connected to a second output port except for the first output port among the plurality of output ports and generating a power change for each wavelength from the optical signal output from the second output port; at least one wavelength measuring unit converting the optical signal passing through the at least one linear transmission filter into the electrical signal; and a wavelength control board unit measuring the wavelength from the electrical signal output from the at least one wavelength measuring unit.

The integrated optical measurement apparatus may further include an interface unit providing an interface with an external device according to the control of the controller.

The integrated optical measurement apparatus may further include a display unit executing a display operation according to the control of the controller.

At least part of the optical signal receiving unit may be implemented as a TO-CAN package or a mini flat package.

According to another exemplary embodiment of the present invention, an integrated optical measurement method of measuring an optical signal by an integrated optical measurement apparatus is provided. The integrated optical measurement method includes: varying a wavelength of an optical signal to be transmitted in an optical signal transmission unit of the integrated optical measurement apparatus according to a wavelength information received from a controller; controlling and outputting power of the optical signal having a wavelength that is varied in the optical signal transmission unit; and measuring power and a wavelength from the optical signal input from the outside in an optical signal receiving unit of the integrated optical measurement apparatus.

The measuring may include: dividing the input optical signal into a plurality of optical signals; measuring the power from one optical signal among the plurality of optical signals; and measuring the wavelength from at least one remaining optical signal among the plurality of optical signals.

The measuring of the wavelength may include measuring a phototransmission amount of the at least one remaining optical signal by using a linear transmission filter changing a phototransmission amount for each wavelength; and measuring the wavelength from the phototransmission amount.

The optical signal transmission unit may include at least one laser diode chip, and the varying may include varying the wavelength of the optical signal by changing a current flowing to the at least one laser diode chip according to the wavelength information.

The outputting may include: distributing the optical signal having the varied wavelength into two optical signals; controlling power of one optical signal of the two optical signals; and fixing the wavelength of the other optical signal of the two optical signals.

The integrated optical measurement method may further include outputting the measured power and wavelength of the optical signal input from the outside to an external device.

### BRIEF DESCRIPTION OF THE DRAWINGS

FIG. 1 is a view showing a configuration of an integrated optical measurement apparatus according to an exemplary embodiment of the present invention.

FIG. 2 is a view showing another example of a wavelength tunable optical output unit shown in FIG. 1.

FIG. 3 is a view showing another example of a power and wavelength measuring unit shown in FIG. 1.

FIG. 4 is a view showing another example of a power and wavelength measuring unit shown in FIG. 1.

FIG. 5 is a view showing a transmission characteristic depending a structure of a linear transmission filter shown in FIG. 1 and an optical wavelength.

FIG. 6 is a view showing a transmission characteristic depending on another structure of a linear transmission filter shown in FIG. 1 and an optical wavelength.

FIG. 7 is a flowchart showing a tunable wavelength method of an optical signal according to an exemplary embodiment of the present invention.

FIG. 8 is a view showing a method of measuring power and a wavelength of an optical signal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprise” and variations such as “comprises” or “comprising” will be understood to imply the inclusion of stated elements but not the exclusion of any other elements.

Now, a method and an apparatus for an integrated optical measurement according to an exemplary embodiment of the present invention will be described in detail with reference to accompanying drawings.

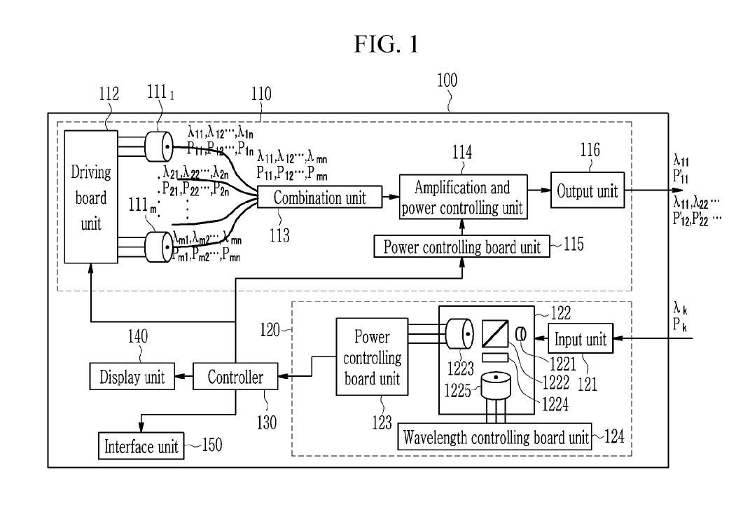

FIG. 1 is a view showing a configuration of an integrated optical measurement apparatus according to an exemplary embodiment of the present invention.

Referring to FIG. 1, an optical measurement apparatus 100 includes an optical signal transmission unit 110, an optical signal receiving unit 120, a controller 130, a display unit 140, and an interface unit 150.

The optical signal transmission unit 110 includes at least one of wavelength tunable transmission units 111₁ to 111ₘ, a driving board unit 112, a combination unit 113, an amplification and power controlling unit 114, a power controller 115, and an output unit 116.

The wavelength tunable transmission units 111₁-111ₘ respectively vary wavelengths to be different from each other, and are driven according to driving control of the driving board unit 112 to vary and output the wavelengths of an optical signal to be transmitted. For example, the wavelength tunable transmission unit 111₁ may vary the wavelength of the optical signal into wavelengths λ₁₁, λ₁₂, . . . , λ₁ₙ of the optical signal respectively having powers P₁₁, P₁₂, . . . , P₁ₙ, the wavelength tunable transmission unit 111₂ may vary the wavelength of the optical signal into wavelengths λ₂₁, λ₂₂, . . . , λ₂ₙ of the optical signal respectively having the powers P₂₁, P₂₂, . . . , P₂ₙ, and the wavelength tunable transmission unit 111ₘ may vary the wavelength of the optical signal into wavelengths λₘ₁, λₘ₂, . . . , λₘₙ of the optical signal respectively having the powers Pₘ₁, Pₘ₂, . . . , Pₘₙ. The wavelength tunable transmission units 111₁-111ₘ may respectively include at least one laser diode chip capable of varying the wavelength of the optical signal. Each of the wavelength tunable transmission units 111₁-111ₘ may freely select a wavelength tunable range according to a number of the laser diode chips. For example, the wavelength tunable transmission unit 111₁ includes four laser diode chips and varies a current flowing to each laser diode chip, thereby varying the wavelength of the input optical signal.

These wavelength tunable transmission units 111₁-111ₘ may be implemented as a TO-CAN package. Alternatively, the wavelength tunable transmission units 111₁-111ₘ may be realized as a type of a mini flat or a package similar thereto.

The driving board unit 112 controls the driving of the wavelength tunable transmission units 111₁-111ₘ according to the control of the controller 130 to output a desired wavelength. That is, if wavelength information is received from the controller 130, the driving board unit 112 controls the driving of the wavelength tunable transmission units 111₁-111ₘ to output the corresponding wavelength. For example, if the desired wavelength is provided from the wavelength tunable transmission unit 111₁, the driving board unit 112 may supply the appropriate current to the wavelength tunable transmission unit 111₁ to output the corresponding wavelength.

The combination unit 113 is connected to the wavelength tunable transmission units 111₁-111ₘ and combines the optical signal output from the wavelength tunable transmission units 111₁-111ₘ to be output to the amplification and power controlling unit 114.

The amplification and power controlling unit 114 amplifies and controls the optical signal output from the combination unit 113 to control the output power of the optical signal.

The power controller 115 controls the amplification and power controlling unit 114 according to the control of the controller 130. The output unit 116 is connected to an external device and outputs the optical signal output from the amplification and power controlling unit 114. The output unit 116 outputs the optical signal having the single wavelength λ₁₁ having the power P′₁₁ or the multiple wavelengths (λ₁₁, λ₂₂, . . . ) having the power P′₁₂, P′₂₂, . . . according to the output of the wavelength tunable transmission units 111₁-111ₘ.

The optical signal receiving unit 120 includes an input unit 121, a power and wavelength measuring unit 122, a power control board unit 123, and a wavelength control board unit 124.

The input unit 121 is connected to the external device, and receives the optical signal having the power Pₖ and the wavelength λₖ from the external device.

The power and wavelength measuring unit 122 includes a collimator lens 1221, an optical separator 1222, a power measuring unit 1223, a linear transmission filter 1224, and a wavelength measuring unit 1225. The power and wavelength measuring unit 122 may also be implemented as the TO-CAN package, and may be implemented as the mini flat or a similar package thereto.

The collimator lens 1221 converges the optical signal input via the input unit 121 without spreading and transfers the optical signal to the optical isolator 1222.

The optical separator 1222 branches the optical signal input from the collimator lens 1221, and then outputs one branched optical signal to the power measuring unit 1223 and outputs the other optical signal to the wavelength measuring unit 1225.

That is, the optical separator 1222 transmits the part of the optical signal input from the collimator lens 1221 and reflects the remaining part, thereby separating the optical signal input from the collimator lens 1221 into two optical signals. The optical separator 1222 may control a ratio of a power amount of the branched optical signal. For example, the optical separator 1222 may select the power amount ratio of the optical signal branched as 1:9, 2:8, 3:7, 4:6, 5:5, etc.

The power measuring unit 1223 receives one optical signal that is branched from the optical separator 1222 and is input, and converts the corresponding optical signal into an electrical signal to be output to the power control board unit 123.

The linear transmission filter 1224 is an element generating the power change for each wavelength of the optical signal. The linear transmission filter 1224 linearly filters the other optical signal that is branched and input from the optical separator 1222 and outputs it to the wavelength measuring unit 1225.

The wavelength measuring unit 1225 converts the optical signal output from the linear transmission filter 1224 into the electrical signal and outputs the electrical signal to the wavelength control board unit 124.

The power control board unit 123 analyzes the electrical signal output from the power measuring unit 1223 to measure the power of the corresponding optical signal.

The wavelength control board unit 124 measures the wavelength of the corresponding optical signal from the electrical signal output from the wavelength measuring unit 1225.

The controller 130 controls the optical signal transmission unit 110, the optical signal receiving unit 120, the display unit 140, and the interface unit 150 and processes all signals and data. The controller 130 may transmit the power and the wavelength of the optical signal measured from the optical signal receiving unit 120 through the interface unit 150, and may display them through the display unit 140. Also, the controller 130 may transmit the power and the wavelength of the optical signal output from the optical signal transmission unit 110 through the interface unit 150, and may display them through the display unit 140. The controller 130 may include at least one processor and may perform corresponding functions by the at least one processor. The processor may be a central processing unit (CPU), a graphics processing unit (GPU), or a dedicated processor in which a method according to exemplary embodiments of the present invention is executed.

The display unit 140 executes the display operation according to the control of the controller 130.

The interface unit 150 provides the external device and the interface function according to the control of the controller 130.

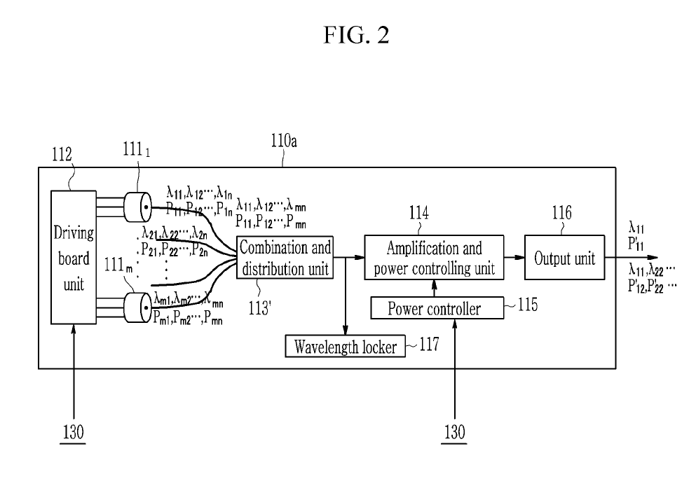

FIG. 2 is a view showing another example of a wavelength tunable optical output unit shown in FIG. 1.

Referring to FIG. 2, an optical signal transmission unit 110a is the same as the optical signal transmission unit 110 shown in FIG. 1 except for a combination and distribution unit 113′ and a wavelength locker 117.

In detail, the combination and distribution unit 113′ combines the optical signals output from at least one of wavelength tunable transmission units 111₁-111ₘ and then divides the optical signals into two optical signals, amplifies and controls one optical signal of the two optical signals to be output to the amplification and power controlling unit 114, and outputs the other optical signal to the wavelength locker 117.

The wavelength locker 117 provides the optical signal of the output wavelength of which the wavelength of the optical signal is not changed depending on a time but is stable.

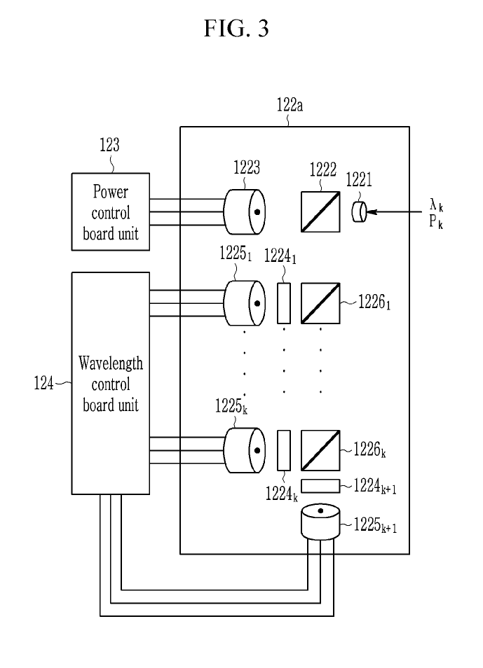

FIG. 3 is a view showing another example of a power and wavelength measuring unit shown in FIG. 1.

Referring to FIG. 3, the power and wavelength measuring unit 122a includes a plurality of wavelength measuring units 1225₁-1225ₖ₊₁, a plurality of linear transmission filters 1224₁-1224ₖ₊₁ positioned respectively corresponding to the plurality of wavelength measuring units 1225₁-1225ₖ₊₁, and a plurality of optical separators 1226₁-1226ₖ to output the other optical signal branched by the optical separator 1222 to the plurality of linear transmission filters 1224₁-1224ₖ₊₁. Each function of the wavelength measuring units 1225₁-1225ₖ₊₁, the linear transmission filters 1224₁-1224ₖ₊₁, and the optical separators 1226₁-1226ₖ is the same as each function of the wavelength measuring unit 1225, the linear transmission filter 1224, and the optical separator 1222 shown in FIG. 1.

In detail, the optical signal passing through the collimator lens 1221 is branched by the optical separator 1222, and one optical signal of the branched optical signals is output to the power measuring unit 1223. Also, the other branched optical signal is again branched by the optical separator 1226₁, one of the branched optical signals is output to the wavelength measuring unit 1225₁ through the linear transmission filter 1224₁, the other branched optical signal is again branched by the optical separator 1226₁, and one branched optical signal is output to the wavelength measuring unit 1225₂ through the linear transmission filter 1224₂. One optical signal of the optical signals branched by the final optical separator 1226ₖ through this process is output to the wavelength measuring unit 1225ₖ though the linear transmission filter 1224ₖ, and the other optical signal is output to the wavelength measuring unit 1225ₖ₊₁ through the linear transmission filter 1224ₖ₊₁. In this case, the linear transmission filters 1224₁-1224ₖ₊₁ are the elements generating the power change for each wavelength of the optical signal, and the wavelength control board unit 124 may measure the multiple wavelengths of the corresponding optical signal from the electrical signals respectively output from the wavelength measuring units 1225₁-1225ₖ₊₁.

As above-described, the optical separators 1226₁-1226ₖ may select the power amount ratio of the optical signal branched to be 1:9, 2:8, 3:7, 4:6, 5:5, etc.

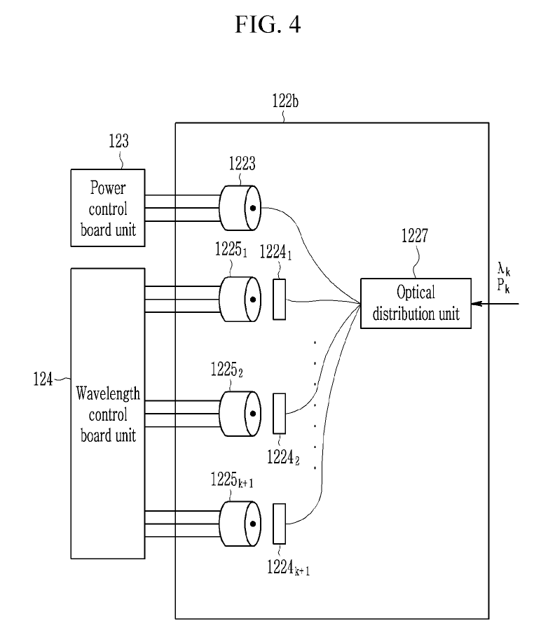

FIG. 4 is a view showing another example of a power and wavelength measuring unit shown in FIG. 1.

Referring to FIG. 4, a power and wavelength measuring unit 122b is the same as the power and wavelength measuring unit 122a shown in FIG. 3, except for using one optical distribution unit 1227 and omitting the collimator lens 1221 and the optical separators 1222 and 1226₁-1226ₖ.

That is, the optical distribution unit 1227 has a plurality of output ports, and the plurality of output ports are respectively connected to the power measuring unit 1223 and at least one of the linear transmission filters 1224₁-1224ₖ₊₁. In FIG. 4, the (k+1) linear transmission filters 1224₁-1224ₖ₊₁ are shown. Accordingly, the optical distribution unit 1227 outputs the optical signal input through the input unit 121 to the power measuring unit 1223 and the plurality of linear transmission filters 1224₁-1224ₖ₊₁ through the plurality of output ports.

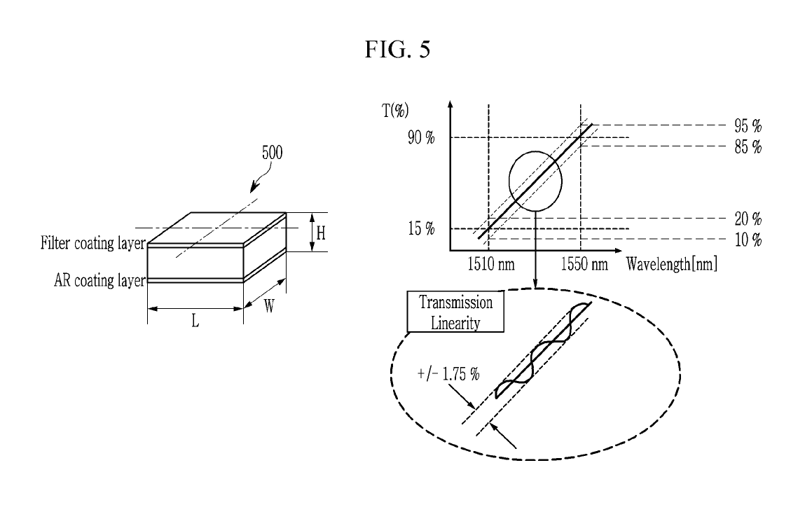

FIG. 5 is a view showing a transmission characteristic depending a structure of a linear transmission filter shown in FIG. 1 and an optical wavelength.

Referring to FIG. 5, a linear transmission filter chip 500 may be used as the linear transmission filter 1224. The linear transmission filter chip 500 shown in FIG. 5 may be configured with a hexahedron shape, and a phototransmission amount T for each wavelength of the input optical signal has a characteristic which is linearly different. FIG. 5 shows an example in which the phototransmission amount T for each wavelength is changed from 10% to 95%. Accordingly, the measuring of the wavelength of the corresponding optical signal is possible through the phototransmission amount T.

Referring to FIG. 1, the optical signal input through the input unit 121 is transmitted to the collimator lens 1221, the optical separator 1222, and the linear transmission filter 1224. In this case, when the linear transmission filter chip 500 is used as the linear transmission filter 1224, the optical signal is output depending on the transmission characteristic of the linear transmission filter chip 500 of which the phototransmission amount according to the optical wavelength is determined, and the optical signal output from the linear transmission filter chip 500 is input to the wavelength measuring unit 1225 and is converted into the electrical signal, thereby being transmitted to the wavelength control board unit 124.

For example, when the power of the optical signal input to the wavelength measuring unit 1225 through the collimator lens 1221 and the optical separator 1222 is referred to as 50 uW, it is assumed that the absolute power of the optical signal considering a loss of the collimator lens 1221 and the optical separator 1222 becomes 120 uW. In this case, as the power of the optical signal input to the wavelength measuring unit 1225 through the linear transmission filter chip 500 is also considered with the loss of the collimator lens 1221 and the optical separator 1222, the finally measured power is divided by 120 uW (or 50 uW without considering the loss) as the absolute power of the optical signal to be normalized, and then the wavelength is measured. For example, if the phototransmission amount T is 0.9 based on the phototransmission amount T for each wavelength shown in FIG. 5, the wavelength of the corresponding optical signal is 1550 nm, and if the phototransmission amount T is 0.15, the wavelength of the corresponding optical signal is 1510 nm.

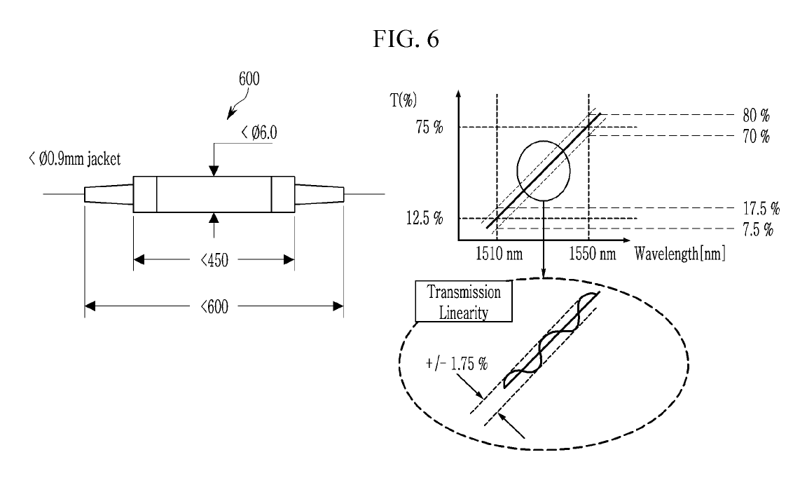

FIG. 6 is a view showing a transmission characteristic depending another structure of a linear transmission filter shown in FIG. 1 and an optical wavelength.

Referring to FIG. 6, a linear transmission filter device 600 may be used as the linear transmission filter 1224. The linear transmission filter device 600 shown in FIG. 6 may change the phototransmission amount for each wavelength from 7.5% to 80%.

For example, when the linear transmission filter device 600 is used as each of the linear transmission filters 1224₁-1224ₖ₊₁ shown in FIG. 4, one optical signal distributed by the optical distribution unit 1227 is output to the power measuring unit 1223, and the other optical signal is output to each linear transmission filter device 600. The optical signal input to each linear transmission filter device 600 is output according to the transmission characteristic of which the phototransmission amount according to the wavelength is determined, and the optical signal output from each linear transmission filter device 600 is output to each of the wavelength measuring units 1225₁-1225ₖ₊₁. After the corresponding optical signal is converted into the electrical signals by each of the wavelength measuring units 1225₁-1225ₖ₊₁, the wavelength for the corresponding optical signal is measured from the corresponding electrical signal in the wavelength control board unit 124.

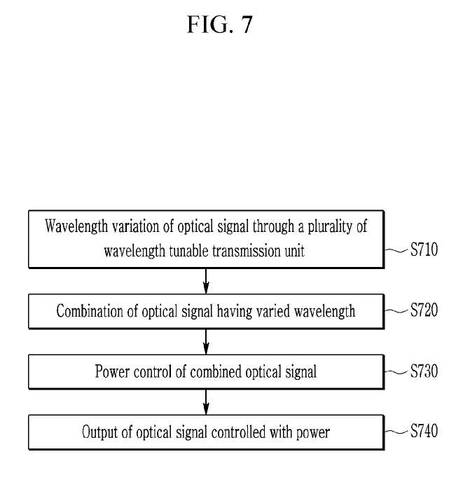

FIG. 7 is a flowchart showing a wavelength tunable method of an optical signal according to an exemplary embodiment of the present invention.

Referring to FIG. 7, the optical signal transmission unit 110 varies the wavelength of the optical signal to be transmitted through the plurality of wavelength tunable transmission units 111₁-111ₘ according to the control of the controller 130 (S710).

The optical signal transmission unit 110 combines and amplifies the optical signals that output from the wavelength tunable transmission units 111₁-111ₘ and are wavelength-varied (S720) to control the power (S730).

The optical signal transmission unit 110 outputs the optical signal of the single wavelength or the multiple wavelengths of which the power is controlled (S740).

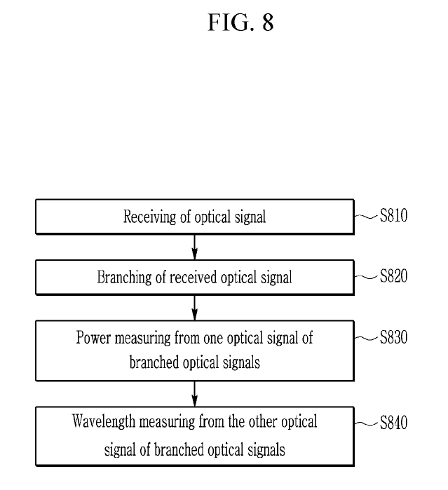

FIG. 8 is a view showing a method of measuring power and a wavelength of an optical signal according to an exemplary embodiment of the present invention.

Referring to FIG. 8, if the optical signal is received from the external device (S810), the optical signal receiving unit 120 branches the received optical signal (S820).

The optical signal receiving unit 120 measures the power from one optical signal of the branched optical signals (S830).

The optical signal receiving unit 120 measures the wavelength from the other optical signal among the branched optical signals (S840). As above-described, the optical signal receiving unit 120 may measure the wavelength of the corresponding optical signal by using the linear transmission filter 1224.

According to an exemplary embodiment of the present invention, as the optical wavelength tuning, the optical power measuring, and the optical wavelength measuring functions may all be provided by only one optical measuring instrument, a size of internal components is small, and the optical module of the transistor outline (TO)-CAN package, the mini flat package, or a package similar thereto is used, there is an advantage that manufacturing in a portable form is possible such that usage at an external site is easy.

Also, it is possible to interface with a smart terminal, thereby providing easy to use functions.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An integrated optical measurement apparatus transmitting an optical signal and processing a received optical signal, comprising:
an optical signal transmission unit varying a wavelength of the optical signal to be transmitted and controlling power of the optical signal such that the wavelength is varied to be output to the outside;
an optical signal receiving unit measuring power and a wavelength from the optical signal input from the outside; and
a controller controlling the optical signal transmission unit and the optical signal receiving unit.

2. The integrated optical measurement apparatus of claim 1, wherein
the optical signal transmission unit includes:
at least one wavelength tunable transmission unit varying the wavelength of the optical signal to be transmitted;
a combination and distribution unit combining at least one optical signal respectively output from the wavelength tunable transmission unit and having the varied wavelength;
an amplification and power controlling unit controlling power of the optical signal combined by the combination unit; and
an output unit outputting a signal of which the power is controlled.

3. The integrated optical measurement apparatus of claim 2, wherein
the optical signal transmission unit further includes a driving board unit controlling driving of at least one wavelength tunable transmission unit to provide the corresponding wavelength depending on wavelength information received from the controller.

4. The integrated optical measurement apparatus of claim 3, wherein
the at least one wavelength tunable transmission unit respectively includes at least one diode chip, and
the driving board unit changes a current flowing to the at least one diode chip depending on the wavelength information to vary the wavelength of the optical signal.

5. The integrated optical measurement apparatus of claim 2, wherein
the optical signal transmission unit further includes a power controller controlling the amplification and power controlling unit depending on the control of the controller.

6. The integrated optical measurement apparatus of claim 2, wherein
the at least one wavelength tunable transmission unit is implemented as a transistor outline (TO)-CAN package or a mini flat package.

7. The integrated optical measurement apparatus of claim 2, wherein
the optical signal transmission unit further includes a wavelength locker fixing the wavelength of the input optical signal, and
the combination and distribution unit distributes the combined optical signals, and then outputs one optical signal to the amplification and power controlling unit and outputs the other optical signal to the wavelength locker.

8. The integrated optical measurement apparatus of claim 1, wherein
the optical signal receiving unit includes:
a first optical separator branching the received optical signal;
a power measuring unit receiving one optical signal output from the first optical separator to be converted into an electrical signal;
a power control board unit measuring the power of the electrical signal output from the power measuring unit;
at least one linear transmission filter generating a power change for each wavelength from the other optical signal output from the first optical separator;
at least one wavelength measuring unit converting the optical signal passing through the at least one linear transmission filter into the electrical signal; and
a wavelength control board unit measuring the wavelength from the electrical signal output from the at least one wavelength measuring unit.

9. The integrated optical measurement apparatus of claim 8, wherein
the optical signal receiving unit further includes at least one second optical separator branching the other optical signal and outputting one branched optical signal to the corresponding linear transmission filter, and
the at least one second optical separator outputs the other branched optical signal to a second optical separator that is positioned next.

10. The integrated optical measurement apparatus of claim 1, wherein
the optical signal receiving unit includes:
an optical distributor outputting the optical signal respectively received through the plurality of output ports;
a power measuring unit connected to a first output port among the plurality of output ports and receiving the optical signal output through the second output port to be converted into the electrical signal;
a power control board unit measuring power from the electrical signal output from the power measuring unit;
at least one linear transmission filter connected to a second output port except for the first output port among the plurality of output ports and generating a power change for each wavelength from the optical signal output from the second output port;
at least one wavelength measuring unit converting the optical signal passing through the at least one linear transmission filter into the electrical signal; and
a wavelength control board unit measuring the wavelength from the electrical signal output from the at least one wavelength measuring unit.

11. The integrated optical measurement apparatus of claim 1, further comprising
an interface unit providing an interface with an external device according to the control of the controller.

12. The integrated optical measurement apparatus of claim 1, further comprising
a display unit executing a display operation according to the control of the controller.

13. The integrated optical measurement apparatus of claim 1, wherein
at least part of the optical signal receiving unit is implemented as a TO-CAN package or a mini flat package.

14. An integrated optical measurement method of measuring an optical signal from an integrated optical measurement apparatus, comprising:
varying a wavelength of an optical signal to be transmitted in an optical signal transmission unit of the integrated optical measurement according to wavelength information received from a controller;
controlling and outputting power of the optical signal having a wavelength that is varied in the optical signal transmission unit; and
measuring power and a wavelength from the optical signal input from the outside in an optical signal receiving unit of the integrated optical measurement apparatus.

15. The integrated optical measurement method of claim 14, wherein
the measuring includes:
dividing the input optical signal into a plurality of optical signals;
measuring the power from one optical signal among the plurality of optical signals; and
measuring the wavelength from at least one remaining optical signal among the plurality of optical signals.

16. The integrated optical measurement method of claim 15, wherein
the measuring of the wavelength includes:
measuring a phototransmission amount of the at least one remaining optical signal by using a linear transmission filter changing a phototransmission amount for each wavelength; and
measuring the wavelength from the phototransmission amount.

17. The integrated optical measurement method of claim 14, wherein
the optical signal transmission unit includes at least one laser diode chip,
the varying includes varying the wavelength of the optical signal by changing a current flowing to the at least one laser diode chip according to the wavelength information.

18. The integrated optical measurement method of claim 14, wherein
the outputting includes:
distributing the optical signal having the varied wavelength into two optical signals;
controlling power of one optical signal of the two optical signals; and
fixing the wavelength of the other optical signal of the two optical signals.

19. The integrated optical measurement method of claim 14, further comprising
outputting the measured power and wavelength of the optical signal input from the outside to an external device.
